(19) United States
(12) Patent Application Publication
(10) Pub. No.: US 2026/0231247 A1
(43) Pub. Date: Aug. 6, 2026

(54) VEHICLE OCCUPANT ENTRY AND EXIT WIRELESS CONNECTION MONITORING

(71) Applicant: Ford Global Technologies, LLC, Dearborn, MI (US)

(72) Inventors: Brendan F. Diamond, Naples, FL (US); Keith Weston, Canton, MI (US); John Robert Van Wiemeersch, Novi, MI (US); Stuart C. Salter, White Lake, MI (US)

(21) Appl. No.: 19/046,868

(22) Filed: Feb. 6, 2025

(51) Int. Cl. H04W 76/10; H04M 1/72409; H04W 4/48; H04W 4/029

(52) U.S. Cl. CPC H04W 76/10; H04M 1/724098; H04W 4/48; H04W 4/029

(57) ABSTRACT

Device locations of access devices are tracked using a wireless transceiver of a vehicle, the wireless transceiver being configured to support wireless communication with the access devices. User locations of users are tracked using a sensor suite of the vehicle, the sensor suite being configured to track the users in proximity to the vehicle. The access devices are correlated with the users, using an access controller, based on correspondence of the device locations to the user locations. Responsive to a single correlated access device being detected, a wireless connection is established with the correlated access device. Responsive to a plurality of correlated access devices being detected, refraining from establishing the wireless connection is performed until one or more of the users enter the vehicle.

### TECHNICAL FIELD

Aspects of the disclosure generally relate to vehicle occupant entry and exit wireless connection monitoring and severance.

### BACKGROUND

Vehicle key fobs may be used to allow a user to gain access to a vehicle. Some fob devices operate such that when a button is pressed on the fob, the device sends a code to the vehicle to instruct the vehicle to unlock the vehicle. Passive entry passive start (PEPS) key fobs operate to provide response to a challenge pulse train sent by the vehicle, where if a proper response is received by the vehicle then the door may be unlocked by a user actuating the door access mechanism of the door.

Phone-as-a-key (PaaK) systems are being introduced to allow users to utilize their phones to unlock a vehicle without requiring a key fob device. These systems may operate similar to a key fob, but where the phone communicates with the vehicle over BLUETOOTH Low Energy (BLE), Ultra-Wide Band (UWB), or other mobile device wireless technologies.

### SUMMARY

In one or more illustrative examples, a vehicle for wireless connection monitoring and severance includes a wireless transceiver configured to support wireless communication with access devices; a sensor suite configured to track locations of users in proximity to the vehicle; and an access controller operatively connected to the wireless transceiver and the sensor suite, wherein the access controller is configured to track device locations of access devices using the wireless transceiver, track user locations of users using the sensor suite, correlate the access devices with the users based on correspondence of the device locations to the user locations, responsive to a single correlated access device being detected, establish a wireless connection with the correlated access device, and responsive to a plurality of correlated access devices being detected, refrain from establishing the wireless connection until one or more of the users enter the vehicle.

In one or more illustrative examples, the access controller is further configured to responsive to user settings of the vehicle indicating that the vehicle is in an owner mode, connect to an access device of an owner user of the vehicle according to the user settings; and refrain from connecting to other correlated access devices.

In one or more illustrative examples, the vehicle further includes a vehicle human machine interface (HMI), operatively connected to the access controller, wherein the access controller is further configured to responsive to the plurality of correlated access devices being detected, display, on the vehicle HMI, a list of the correlated access devices; receive a user selection of one of the correlated access device from the list; and establish the wireless connection with the selected one of the correlated access devices.

In one or more illustrative examples, the access controller is further configured to indicate a recommendation on the vehicle HMI, the recommendation indicating which of the correlated access devices is recommended for reconnection, the recommendation being determined as a most recently connected correlated access device, most commonly connected correlated access device, owner correlated access device, and/or the correlated access device in a driver position in the vehicle.

In one or more illustrative examples, the access controller is further configured to track the user locations using object recognition techniques on data from the sensor suite to distinguish human users from other objects.

In one or more illustrative examples, the access controller is further configured to terminate the wireless connection between the vehicle and the access device responsive to determining that the correlated access device is exiting; and prevent automatic reconnection of the access device to the vehicle for a predefined timer period after the wireless connection is terminated.

In one or more illustrative examples, the access controller is further configured to maintain the wireless connection while a user associated with the access device is outside the vehicle, provided the user is within a predefined range from the vehicle; and suppress notifications to a vehicle HMI while maintaining use of entertainment and navigation applications until the user returns to inside the vehicle.

In one or more illustrative examples, the access controller is further configured to reply to incoming messages with a pre-configured away reply while the user is outside the vehicle.

In one or more illustrative examples, the access controller is further configured to indicate any missed messages or calls responsive to the user returning to inside the vehicle.

In one or more illustrative examples, a method for wireless connection monitoring and severance includes tracking device locations of access devices using a wireless transceiver of a vehicle, the wireless transceiver being configured to support wireless communication with the access devices; tracking user locations of users using a sensor suite of the vehicle, the sensor suite being configured to track the users in proximity to the vehicle; correlating the access devices with the users, using an access controller, based on correspondence of the device locations to the user locations; responsive to a single correlated access device being detected, establishing a wireless connection with the correlated access device; and responsive to a plurality of correlated access devices being detected, refraining from establishing the wireless connection until one or more of the users enter the vehicle.

In one or more illustrative examples, the method further includes responsive to user settings of the vehicle indicating that the vehicle is in an owner mode, connecting to an access device of an owner user of the vehicle according to the user settings, responsive to the correlated access device of the owner user being detected inside the vehicle; and refraining from connecting to other correlated access devices.

In one or more illustrative examples, the method further includes displaying, on a vehicle HMI, a list of the correlated access devices; receiving a user selection of one of the correlated access device from the list; and establishing the wireless connection with the selected one of the correlated access devices.

In one or more illustrative examples, the method further includes indicating a recommendation on the vehicle HMI, the recommendation indicating which of the correlated access devices is recommended for reconnection, the recommendation being determined as a most recently connected correlated access device, most commonly connected correlated access device, owner correlated access device, and/or the correlated access device in a driver position in the vehicle.

In one or more illustrative examples, the method further includes tracking the user locations using object recognition techniques on data from the sensor suite to distinguish human users from other objects.

In one or more illustrative examples, the method further includes terminating the wireless connection between the vehicle and the access device responsive to determining that the correlated access device is exiting; and preventing automatic reconnection of the access device to the vehicle for a predefined timer period after the wireless connection is terminated.

In one or more illustrative examples, the method further includes maintaining the wireless connection while a user associated with the access device is outside the vehicle, provided the user is within a predefined range from the vehicle; and suppressing notifications to a vehicle HMI while maintaining use of entertainment and navigation applications until the user returns to inside the vehicle.

In one or more illustrative examples, the method further includes replying to incoming messages with a pre-configured away reply while the user is outside the vehicle.

In one or more illustrative examples, the method further includes indicating any missed messages or calls responsive to the user returning to inside the vehicle.

In one or more illustrative examples, a non-transitory computer-readable medium includes instructions for wireless connection monitoring and severance that, when executed by one or more processors of an access controller of a vehicle, cause the vehicle to perform operations including to track device locations of access devices using a wireless transceiver of a vehicle, the wireless transceiver being configured to support wireless communication with the access devices; track user locations of users using a sensor suite of the vehicle, the sensor suite being configured to track the users in proximity to the vehicle; correlate the access devices with the users, using an access controller, based on correspondence of the device locations to the user locations; responsive to a single correlated access device being detected, establish a wireless connection with the correlated access device; and responsive to a plurality of correlated access devices being detected, refrain from establishing the wireless connection until one or more of the users enter the vehicle.

In one or more illustrative examples, the non-transitory computer-readable medium further includes instructions that, when executed by the one or more processors of the access controller, cause the vehicle to perform operations including to: terminate the wireless connection between the vehicle and the access device responsive to determining that the correlated access device is exiting; and prevent automatic reconnection of the access device to the vehicle for a predefined timer period after the wireless connection is terminated.

In one or more illustrative examples, an access device configured for wireless communication with a plurality of vehicles, the access device comprising a wireless transceiver configured to support wireless communication with vehicles; a device HMI; and a processor operatively connected to the wireless transceiver, wherein the processor is configured to track vehicles using the wireless transceiver, responsive to a single vehicle being detected, establish a wireless connection with the vehicle, and responsive to multiple vehicles being detected refrain from connecting to any of the multiple vehicles, display a vehicle selection user interface on the device HMI, the vehicle selection user interface listing the multiple vehicles detected, receive, via the vehicle selection user interface, a selection of a specific vehicle, and allow the access device to connect to the specific vehicle while refusing to connect to any other vehicles of the multiple vehicles.

In one or more illustrative examples, the vehicle selection user interface displays a list of the multiple vehicles, including, for each detected vehicle, at least one of: a name associated with the detected vehicle, a time of last connection with the access device, and a distance of the detected vehicle from the access device.

In one or more illustrative examples, the vehicle selection user interface includes a recommendation for one of the multiple vehicles based on one or more criteria including a most recently connected vehicle, a most frequently connected vehicle, or a nearest detected vehicle.

In one or more illustrative examples, the access device is further configured to track vehicle locations of the vehicles using signal trilateration or triangulation and use the vehicle locations to determine the nearest detected vehicle.

In one or more illustrative examples, the access device is further configured to store historical connection data for previously connected vehicles and use the historical connection data to determine the most recently connected vehicle and/or the most frequently connected vehicle.

### BRIEF DESCRIPTION OF THE DRAWINGS

FIG. 1 illustrates a system including a vehicle configured for vehicle occupant entry and exit wireless connection monitoring and severance;

FIG. 2 illustrates an example of multiple users with access devices traversing the parking lot;

FIG. 3 illustrates an example access device selection user interface;

FIG. 4 illustrates an example process for vehicle occupant entry wireless connection monitoring and severance;

FIG. 5 illustrates an example of a user with an access device exiting one of the vehicles in the parking lot;

FIG. 6 illustrates an example process for vehicle occupant exit wireless connection monitoring and severance;

FIG. 7 illustrates an example of a user with an access device traversing the parking lot having a plurality of vehicles;

FIG. 8 illustrates an example vehicle selection user interface;

FIG. 9 illustrates an example process for access device entry wireless connection monitoring and severance; and

FIG. 10 illustrates an example computing device for use in implementing the vehicle occupant entry and exit wireless connection monitoring and severance.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Many vehicle users have their phones wirelessly linked to multiple vehicles as access devices. This can occur, for example, where multiple vehicles of a fleet are on-site or potentially used as offices, or in a family setting with multiple vehicles in a driveway or garage. When these users are close to one or more vehicles, one of the vehicles may attempt to connect to that user’s access device. For example, a vehicle may be started and may pair to the access device of a user that is outside that vehicle. Additionally, while exiting a vehicle, the vehicle may continue to attempt to reconnect to the departing access device, even though the user has no intention of using the access device in collaboration with the vehicle in the immediate future. These behaviors may be unexpected for the user or other potential users of that or nearby associated vehicles.

Aspects of the disclosure relate to a vehicle occupant entry and exit wireless connection monitoring and severance approach. The approach may monitor the mobile access devices and users to determine who is entering and exiting the vehicle. This monitored information may be used to control the connection status of the vehicle and the user’s access device.

When a user having an access device associated with the vehicle is entering and/or approaching the vehicle, the vehicle may use the exterior and interior sensor suite to identify the occupant and determine which mobile device that user is associated with. This association may be inferred based on historical data regarding which access devices have been connected to the vehicle in the past in combination with that user. Using this information, the vehicle may attempt to wirelessly connect to that specific access device using various communication protocols (e.g., BLE, Wi-Fi, etc.). In some examples, selective enablement and control of predefined vehicle features may be applied in the vehicle settings to only pair the access device when the user who owns the access device is located inside the vehicle.

When a user is exiting the vehicle, the vehicle may perform additional operations to terminate the wireless connection so as to address errant reconnects and inconvenience to the user. The vehicle may first identify and classify that the occupant is leaving the vehicle. If the user is leaving, the vehicle may sever the connection to prevent interference and/or reconnection attempts with the vehicle. Further aspects of the disclosure are discussed in detail herein.

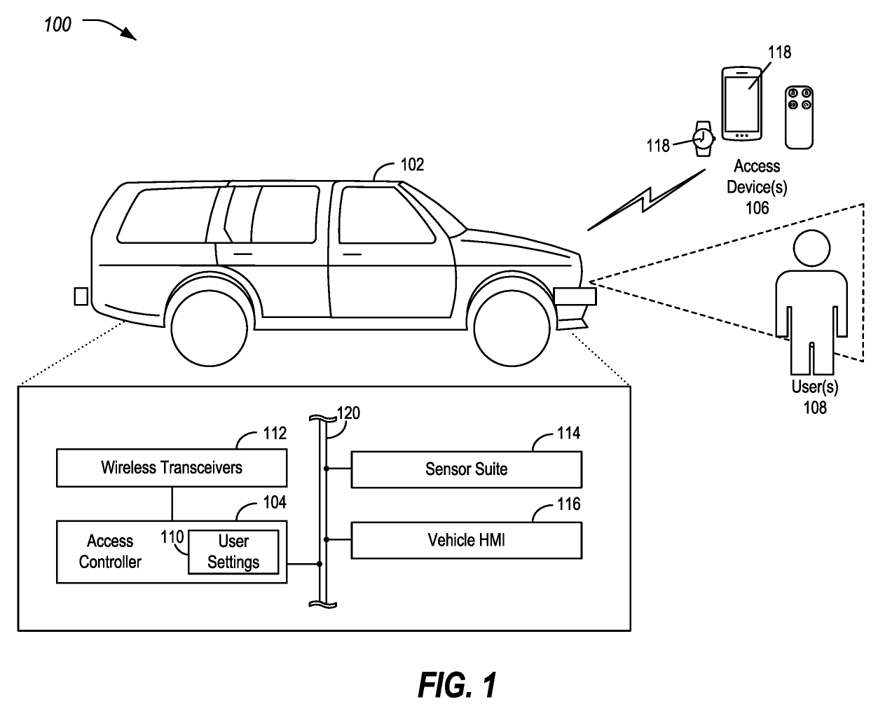

FIG. 1 illustrates a system 100 including a vehicle 102 configured for vehicle occupant entry and exit wireless connection monitoring and severance. The vehicle 102 may include an access controller 104 configured to detect access devices 106. The access controller 104 may store user settings 110 and may be in in communication with wireless transceivers 112. The vehicle 102 may also include a sensor suite 114 for detection of users 108 and a vehicle human machine interface (HMI) 116. The access devices 106 may also include a device HMI 118. The components of the vehicle 102 may communicate with one another over various vehicle buses 120. It should be noted that the illustrated system 100 is only an example, and systems 100 with more, fewer, or different components may be used. Additionally, while only a single vehicle 102 and user 108 are shown in FIG. 1, many real-world systems 100 may have many vehicles 102, access devices 106, and users 108.

The vehicle 102 may include various types of vehicle, crossover utility vehicle (CUV), sport utility vehicle (SUV), truck, recreational vehicle (RV), motorcycle, boat, trains, plane or other mobile machine for transporting people or goods. Such vehicles 102 may be human-driven or autonomous. In many cases, the vehicle 102 may be powered by an internal combustion engine. As another possibility, the vehicle 102 may be a battery electric vehicle powered by one or more electric motors. As a further possibility, the vehicle 102 may be a hybrid electric vehicle powered by both an internal combustion engine and one or more electric motors, such as a plug-in hybrid electrical vehicle. Alternatively, the vehicle 102 may be an autonomous vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs).

The vehicle 102 may include one or more controllers configured to perform and manage various vehicle 102 functions under the power of the vehicle battery and/or drivetrain. The controllers may include various types of computing devices in support of performance of the functions of the controllers described herein. In an example, the controllers may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, the processor receives instructions and/or data, e.g., from the storage, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, JavaScript, Perl, etc. As depicted, the example vehicle controllers are represented as discrete controllers. However, the vehicle controllers may share physical hardware, firmware, and/or software, such that the functionality from multiple controllers may be integrated into a single controller, and that the functionality of various such controllers may be distributed across a plurality of controllers.

The access controller 104 is a controller of the vehicle 102 configured to manage access control mechanisms, including user authentication, signal verification, and lock/unlock commands. The access controller 104 may include a secure processing module that ensures sensitive operations, such as cryptographic key exchange and storage, are resistant to tampering or unauthorized access. The access controller 104 may further integrate with other systems of the vehicle 102, such as an alarm system or immobilizer, to enhance security.

The access devices 106 may include mobile phones, wearables such as smartwatches, key fobs, or other wireless-enabled devices. In many examples, the access devices 106 are associated with and carried by users 108. The access devices 106 may be paired with the vehicle 102 using cryptographic protocols to ensure secure data exchange and prevent unauthorized access. Pairing may occur during an initial setup process, where unique identifiers for the access devices 106 are stored to user settings 110 of the access controller 104. In some configurations, the access devices 106 may also store digital keys issued by the vehicle 102 manufacturer or owner, enabling temporary or limited access to other users 108. Such temporary keys may include time-based restrictions or geofencing rules for enhanced control. Additionally, the access controller 104 may maintain a log of access events in the user settings 110, including the identity of access devices 106 and timestamps, to provide a record of vehicle 102 entry and exit.

The access controller 104 may be in communication with one or more wireless transceivers 112. The wireless transceivers 112 may include hardware and software components capable of supporting a range of wireless communication protocols, such as BLE, UWB, Wi-Fi, or Near Field Communication (NFC). These protocols enable communication between the access devices 106 and the access controller 104. UWB may allow for centimeter-level precision in determining the position of an access device 106 relative to the vehicle 102, while BLUETOOTH may facilitate a measurement of signal strength which may provide a more coarse measure of distance to a user 108 with a lower power budget.

The access controller 104 may determine the approach or departure of an access device 106 by analyzing various signal parameters received via the wireless transceiver 112. For example, increased BLE signal strength or decreased round-trip Radio Frequency Time-of-Flight (RF-ToF) may indicate that an access device 106 is approaching the vehicle 102, triggering actions such as illuminating external lights, unlocking doors, or activating a welcome message. Conversely, decreased BLE signal strength or increased round-trip RF-ToF may indicate that the access device 106 is moving away from the vehicle 102, prompting the access controller 104 to lock the vehicle, disable internal systems, or send a notification to the user 108 confirming vehicle security.

The vehicle 102 may also make use of the sensor suite 114 in order to receive information with respect to the surroundings of the vehicle 102. In an example, the sensor suite 114 may include one or more of cameras (e.g., advanced driver assistance system (ADAS) cameras), ultrasonic sensors, radio detection and ranging (RADAR) systems, and/or light detection and ranging (LIDAR) systems. The sensor suite 114 may be used to allow the vehicle 102 to image its surroundings. For instance, camera sensors mounted on the front, rear, and sides of the vehicle 102 may be used to capture visual images of the surroundings of the vehicle 102. These images may be used, for example, to confirm the positions of users 108 who are carrying access device 106, to identify the positions of objects surrounding the vehicle 102, to detect the positions of users 108 who are not carrying access device 106, etc.

The vehicle HMI 116 may be configured to receive input from a user 108 to the vehicle 102 via various buttons or other controls, as well as provide vehicle status information using one or more lights, speakers, and/or display screens to present information. This information may include, as some examples, fuel or charge level information, engine operating temperature information, and current location of the vehicle 102. The vehicle HMI 116 may be configured to provide information to various displays within the vehicle 102, such as a center stack touchscreen, a gauge cluster screen, etc.

Similarly, the access devices 106 may include a device HMI 118. The device HMI 118 may be configured to receive input from a user 108 to the access device 106 via various buttons or other controls, as well as provide vehicle status information using one or more lights, speakers, and/or display screens.

A vehicle bus 120 may include various methods of communication available between the various components of the vehicle 102 discussed herein. As some non-limiting examples, the vehicle bus 120 may include one or more of a vehicle controller area network (CAN), an Ethernet network, a media-oriented system transfer (MOST) network, and/or a wireless network. While a single vehicle bus 120 is illustrated, it should be noted that in many examples, multiple vehicle buses 120 are included, with a subset of the controllers connected to each vehicle bus 120.

The positions of users 108 around the vehicle 102 may be tracked using the access devices 106 and/or using the sensor suite 114 of the vehicle 102. Based on these positions, one or more doors of the vehicle 102 may be automatically locked or unlocked. For example, the access controller 104 may unlock a door of the vehicle 102 responsive to detection of an approach of an authorized user 108 via the wireless transceiver 112.

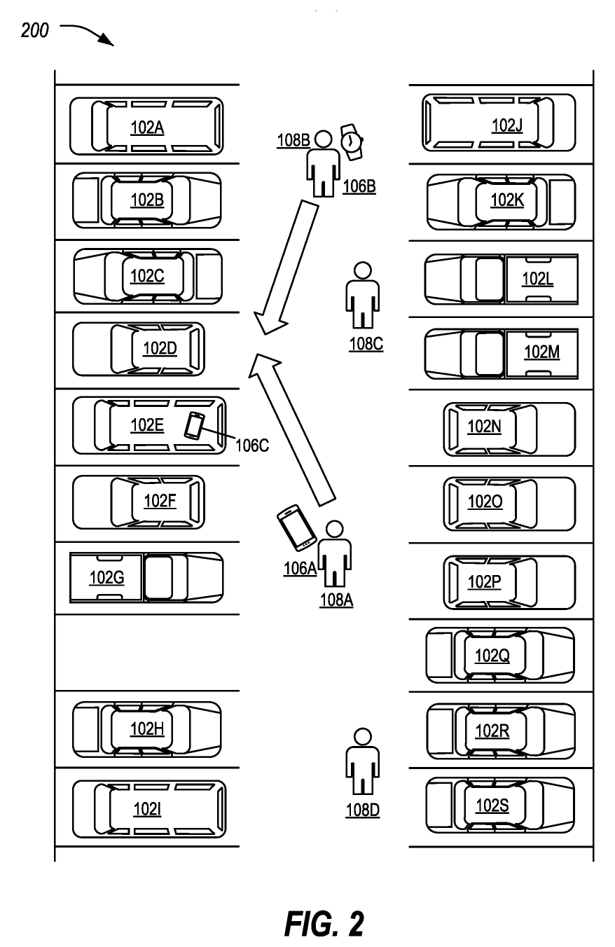

FIG. 2 illustrates an example of multiple users 108 with access devices 106 traversing a parking lot 200. As shown, a first access device 106A is being carried by a first user 108A, and a second access device 106B is being carried by a second user 108B. There is also a third user 108C and a fourth user 108D, neither of whom is carrying access device 106. There is also an access device 106C left unattended in the vehicle 102E, without the associated user 108 being present.

As the users 108A and 108B are both detectable by many or even all the vehicles 102 in the parking lot 200, it may be difficult for the various vehicles 102 to identify which, if any, of the access devices 106 is approaching which of the vehicles 102 (if the vehicles 102 are being approached at all). In such a situation, the access controller 104 may be configured to refrain from automatically unlocking the vehicle 102 responsive to detection of multiple access devices 106.

Moreover, it may be unclear to the vehicles 102 whether the unattended access device 106C should connect to any of the vehicles 102. It may also be unclear to the vehicle 102 how to address the users 108C, 108D who do not have access devices 106. For such situations, the access controller 104 may be configured to correlate access devices 106 detected using the wireless transceiver 112 with users 108 detected using the sensor suite 114. Accordingly, only correlated user 108 to access device 106 sets may be considered as potential candidates for connection to the vehicle 102.

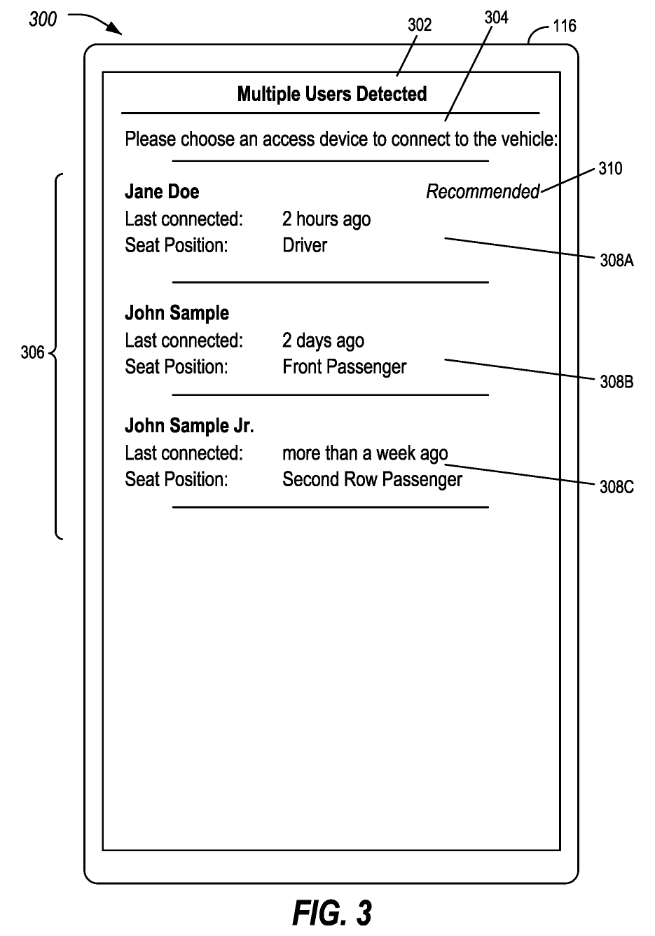

In some cases, multiple correlated user 108 to access device 106 sets may be detected. In such cases, the vehicle 102 may be configured to connect only to a main or preferred access device 106. In other cases, the vehicle 102 may request for the user 108 to select which access device 106 should connect to the vehicle 102. An example HMI for doing so is discussed with respect to FIG. 3.

FIG. 3 illustrates an example access device selection user interface 300. The access device selection user interface 300 may be used to allow the vehicle 102 to receive an indication of which of multiple detected access devices 106 should be connected to the vehicle 102. In an example, the access device selection user interface 300 may be provided by the vehicle HMI 116 to a display within the cabin of the vehicle 102. In another example, the access device selection user interface 300 may be provided on the device HMI 118 of an access device 106 in communication with the vehicle 102.

The access device selection user interface 300 provides a title 302 indicating that multiple users 108 are detected. The access device selection user interface 300 further provides instructions 304 that the access device selection user interface 300 is available for receiving a selection from the available detected access devices 106.

The access device selection user interface 300 also illustrates a device list 306 of the detected access device 106 which are correlated to users 108. The device list 306 may include various information about the detected devices, such as names of the users 108 corresponding to those devices, a time that the access device 106 was last connected to the vehicle 102, and/or a location of the user 108 in the vehicle 102. As shown, a first correlated device indication 308A is for a first user 108, Jane Doe, who was last connected two hours ago, and who is located in the driver position. A second correlated device indication 308B is for a second user 108, John Sample, who was last connected two days ago and who is located as the front passenger. A third correlated device indication 308C is for a third user 108, John Sample Jr., who was last connected more than a week ago and who is located in the second row of the vehicle 102. The name of the user 108 may be the name that was entered for the access device 106 when it was paired to the vehicle 102 originally and/or may be the name of an account of the user 108 associated with the access device 106.

The access device selection user interface 300 may also indicate a recommendation 310, which indicates which of the access devices 106 is suggested by the vehicle 102 for reconnection. This recommendation 310 may be determined by the vehicle 102, for example, to suggest one or more of the most recently connected access device 106, the most commonly connected access device 106, the access device 106 most likely located at a driver position, the owner access device 106, etc. Using the access device selection user interface 300, an occupant of the vehicle 102 may select the desired access device 106 for connection to the vehicle 102.

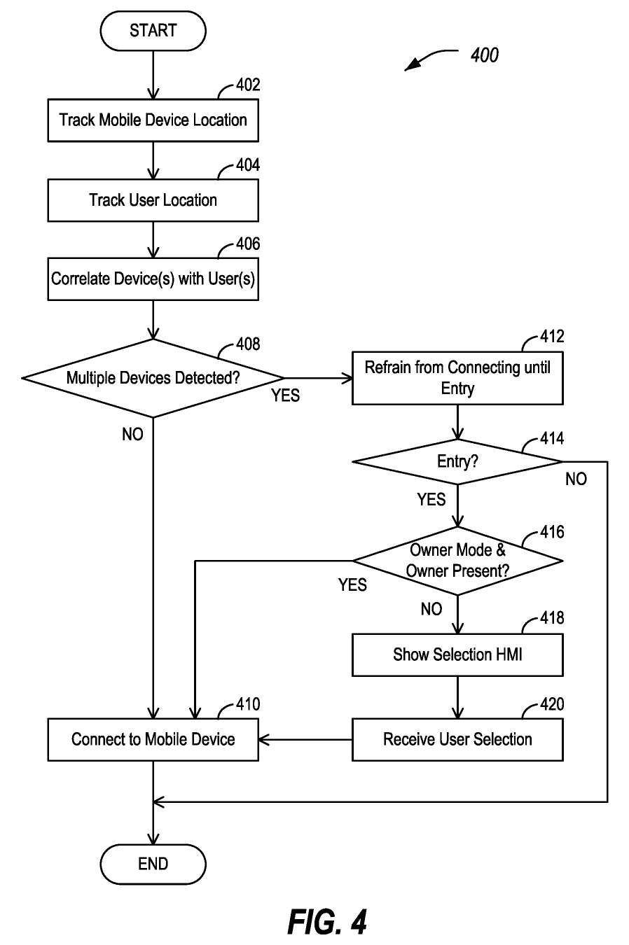

FIG. 4 illustrates an example process 400 for vehicle occupant entry wireless connection monitoring and severance. In an example, the process 400 may be performed by one or more of the vehicles 102 discussed in detail herein. When executed, the process 400 may allow the vehicles 102 to address issues such as those discussed with respect to FIG. 2.

At operation 402, the vehicle 102 tracks locations of the access device 106. In an example, the location of the access device 106 may be wirelessly tracked using signal trilateration or triangulation via BLE and/or UWB transmissions between the access device 106 and the access controller 104.

At operation 404, the vehicle 102 tracks locations of users 108. In an example, the location of the user 108 may be tracked using the sensor suite 114 of the vehicle 102. For instance, RADAR, LIDAR, and/or camera sensors may be used to capture movement and/or location information with respect to users 108 moving in proximity to the vehicle 102. In some cases, object recognition techniques may be performed on the sensor data to confirm that the detected movement corresponds to a human being as opposed to another type of object such as an animal, leaves, rain, water, etc.

At operation 406, the vehicle 102 correlates tracked access devices 106 with tracked users 108. In an example, the vehicle 102 may also compare an estimated location of each of the tracked access devices 106 with tracked location of each of the users 108. This may be of the user 108 using and the vehicle exterior sensor suite 114. If the access device 106 and user 108 are in the same location and/or are the same Euclidean distance away from the vehicle 102, the vehicle 102 may associate that access device 106 as being is associated with that user 108. A predefined bounds factor such as a one meter offset may be used to as a limit for access devices 106 and users 108 being deemed to be in the same location.

At operation 408, the vehicle 102 determines whether multiple access devices 106 are detected. In an example, the vehicle 102 may, based on the correlation, determine that only a single access device 106 with associated user 108 is moving in proximity to the vehicle 102. If so, control proceeds to operation 410. If more than a single access device 106 with associated user 108 is moving in proximity to the vehicle 102, control passes to operation 412.

At operation 410, the vehicle 102 connects to the access device 106. Accordingly, the access device 106 may be able to share functionality and settings of the access device 106 with the vehicle 102. After operation 410, the process 400 end.

At operation 412, the vehicle 102 refrains from connecting to any of the tracked access devices 106. This is done because it is unclear which user 108, if any, intends to access the vehicle 102.

At operation 414, the vehicle 102 determines whether entry to the vehicle 102 is initiated or performed. The determination of entry may be performed, for example, responsive to detection that the approaching user 108 has actuated the door access switch or handle. In another example, the determination may be performed responsive to detection of opening of one of the vehicle doors. In yet another example, the determination may be performed responsive to detection of a user 108 in a vehicle cabin location using the sensor suite 114 (e.g., detection of weight when a user 108 sits down, detection of attachment of a buckle, etc.). If no entry is detected, the process 400 ends. If entry is detected, control proceeds to operation 416.

At operation 416, the vehicle 102 determines if the vehicle 102 is in owner mode and also that the owner access device 106 is present. The owner mode may be a user setting 110 of the vehicle 102 in which the vehicle 102 only pairs with the access device 106 of the owner when the owner is inside the vehicle 102. If this setting is set, and if the owner access device 106 is detected, control passes to operation 410 to cause the vehicle 102 to connect to the owner access device 106. If not, control proceeds to operation 418.

At operation 418, the vehicle 102 displays the access device selection user interface 300. In an example, vehicle 102 displays, to the vehicle HMI 116, a pop-up of a list of access devices 106 that are detected and correlated with users 108. The access device selection user interface 300 may further illustrate a suggested one of the access devices 106. The suggested access device 106 may be focused on a most recently used access device 106, and/or the access device selection user interface 300 may show the most frequently used access devices 106 first.

At operation 420, the HMI receives a selection from a user 108 of the choice of which access device 106 is to be connected to the vehicle 102. After operation 420, control passes to operation 410 to cause the vehicle 102 to connect to the selected access device 106.

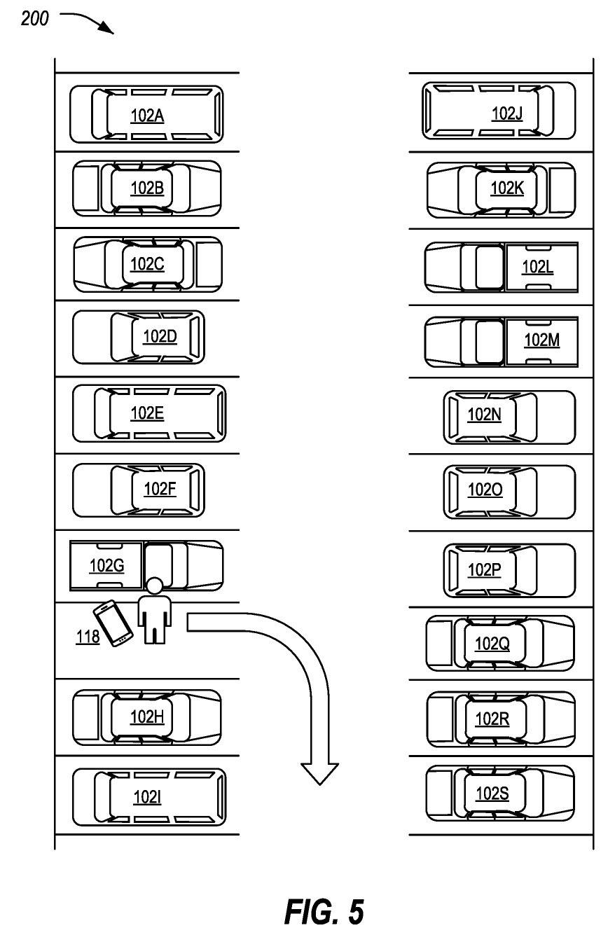

FIG. 5 illustrates an example of a user 108 with an access device 106 exiting one of the vehicles 102 in the parking lot 200. In this example, it is assumed that the access device 106 has previously been connected to the vehicle 102G that the user 108 has exited. In such a situation, it may be objectionable for the access device 106 to attempt to reconnect to the vehicle 102G, let alone attempt a new connection to any of the other vehicles 102 in the parking lot 200 as the user 108 is likely leaving the parking lot 200.

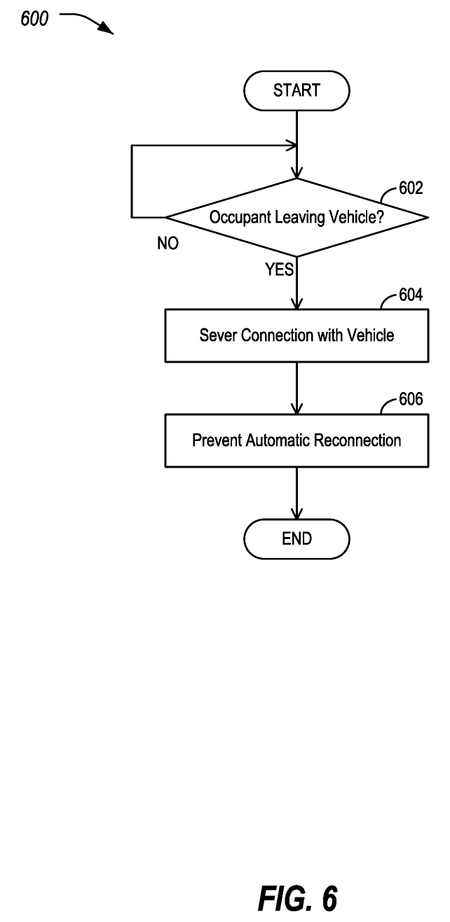

FIG. 6 illustrates an example process 600 for vehicle occupant exit wireless connection monitoring and severance. In an example, the process 600 may be performed by one or more of the vehicles 102 discussed in detail herein. When executed, the process 600 may allow the vehicles 102 to address issues such as those discussed with respect to FIG. 5.

At operation 602, the vehicle 102 determines whether the user 108 whose access device 106 is connected to the vehicle 102 is leaving the vehicle 102. This identification of an occupant leaving the vehicle 102 may be based on various factors, such as a buckle becoming unlatched of the position in the vehicle 102 where the connected user 108 is located, the vehicle 102 going from key on to key off, detection of the specific user 108 whose access device 106 is connected reaching a predefined distance away from the vehicle 102, signal strength of the access device 106 falling below a calibrated threshold, etc. If the occupant user 108 whose access device 106 is connected to the vehicle 102 is leaving, control proceeds to operation 604.

At operation 604, the vehicle 102 terminates the connection to the access device 106. As a result, phone calls and messages to the access device 106 may be directed to the access device 106 only and would not ring inside the vehicle 102.

At operation 606, the vehicle 102 prevents automatic reconnection of the access device 106. In an example, the vehicle 102 may set a timer period during which the access device 106 will be refused connection to the vehicle 102. This timer period may be overridden by affirmative selection of the access device 106 for pairing via the vehicle HMI 116. In another example, the access device 106 may additionally or alternately refuse to connect to vehicles 102 for a predefined timer period. After operation 606, the process 600 ends.

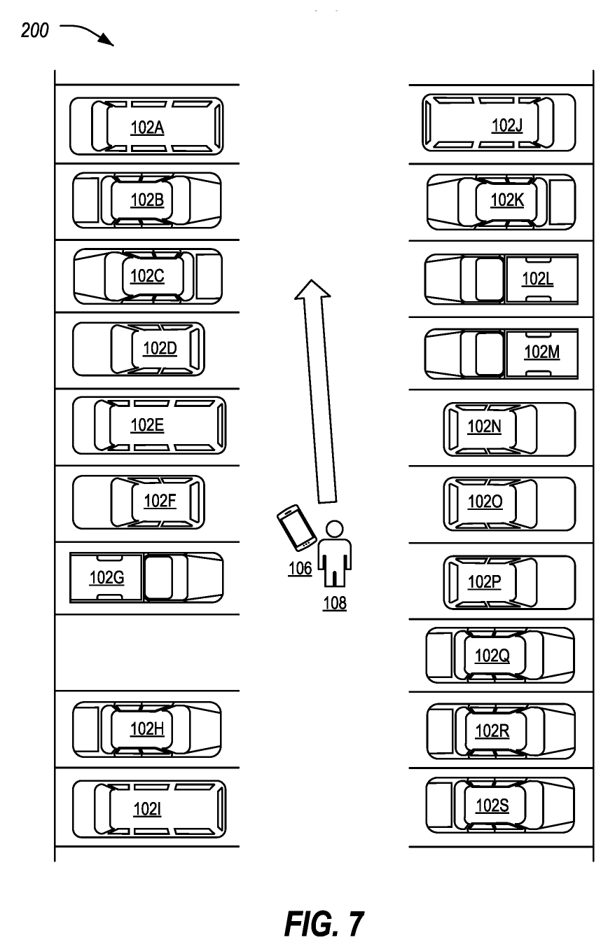

FIG. 7 illustrates an example of a user 108 with an access device 106 traversing the parking lot 200 having a plurality of vehicles 102 (here vehicles 102A-102S). In the example, it is assumed that the access device 106 has previously been paired with or otherwise been used to access at least a subset of the plurality of vehicles 102.

In such a situation where the access device 106 is paired with many of the vehicles 102 (such as when a fleet user 108 walks through the parking lot 200 of a fleet), it would be unwanted for the movement of the user 108 through the parking lot 200 to cause many of the vehicles 102 to unlock or show welcome messages due to the proximity of the passing user 108 to the vehicles 102. Because the intent of the user 108 is unclear, the access device 106 may refrain from attempting connection to any of the vehicles 102. Or, in another example, the access device 106 may prompt the user 108 to select which of the vehicles 102 the access device 106 intends to connect to.

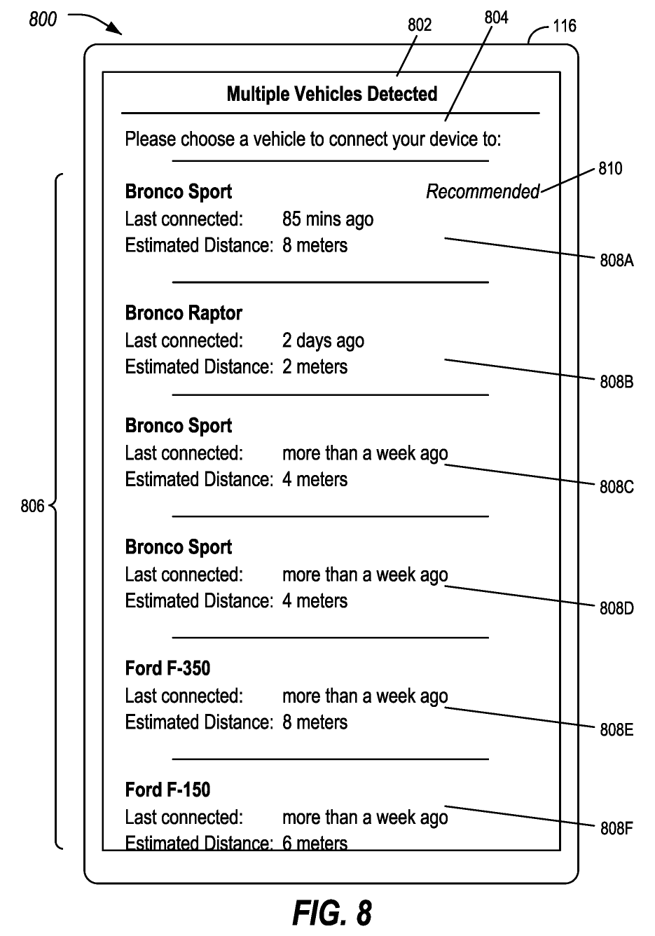

FIG. 8 illustrates an example vehicle selection user interface 800. The vehicle selection user interface 800 may be used to allow the access device 106 to choose which of multiple detected vehicles 102 should be connected to the access device 106. In an example, the vehicle selection user interface 800 may be provided by the device HMI 118.

The vehicle selection user interface 800 provides a title 802 indicating that multiple vehicles 102 are detected. The vehicle selection user interface 800 further provides instructions 804 that the vehicle selection user interface 800 is for receiving a selection from the available detected vehicles 102.

The vehicle selection user interface 800 also illustrates a vehicle list 806 of the detected vehicles 102. The vehicle list 806 may include various information about the detected vehicles 102, such as names in the access device 106 paired device data of the names corresponding to those vehicles 102, a time that the access device 106 was last connected to the vehicle 102, and/or a distance of the access device 106 to the vehicle 102.

As shown, a first connection target 808A is for a first vehicle 102, Bronco Sport, which was last connected to eighty-five minutes ago, and which is located eight meters away. A second connection target 808B is for a second vehicle 102, Bronco Raptor, which was last connected to two days ago, and which is located two meters away. A third connection target 808C is for a third vehicle 102, Bronco Sport, which was last connected to more than a week ago, and which is located four meters away. A fourth connection target 808D is for a fourth vehicle 102, Bronco Sport, which was last connected to more than a week ago, and which is located four meters away. A fifth connection target 808E is for a fifth vehicle 102, Ford F-350, which was last connected to more than a week ago, and which is located eight meters away. A sixth connection target 808F is for a sixth vehicle 102, Ford F-150, which was last connected to more than a week ago, and which is located six meters away.

The vehicle selection user interface 800 may also indicate a recommendation 810, which indicate which connection target 808 (e.g., here selected from connection targets 808A-808E) is suggested by the access device 106 for reconnection. This recommendation 810 may be determined by the access device 106, for example, to suggest one or more of the most recently connected vehicles 102, and/or nearest vehicles 102, etc. In some examples, the access device 106 may store historical connection data for previously connected vehicles 102 and use the historical connection data to prioritize the display of vehicles 102 in the vehicle selection user interface 800. Using the vehicle selection user interface 800, an occupant of the vehicle 102 may select the vehicle 102 for connection to the access device 106. This may involve the access device 106 refusing connection to any of the other vehicles 102 and/or proceeding with connection to the selected vehicle 102.

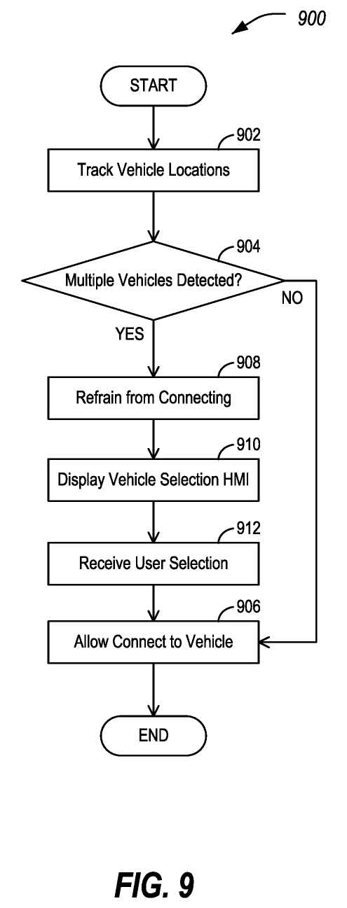

FIG. 9 illustrates an example process 900 for access device 106 entry wireless connection monitoring and severance. In an example, the process 900 may be performed by an access device 106 in communication with one or more vehicles 102 as discussed in detail herein. When executed, the process 900 may allow the access device 106 to address issues such as those discussed with respect to FIG. 7.

At operation 902, the access device 106 tracks locations of the vehicles 102. In an example, the location of the vehicle 102 may be wirelessly tracked using signal triangulation via BLE and/or UWB transmissions between the access device 106 and the access controller 104 of the vehicle 102.

At operation 904, the access device 106 determines whether multiple vehicles 102 are detected. If the access device 106 determines that only a single vehicle 102 is in proximity to the vehicle 102, control passes to operation 906 to allow the vehicle 102 and access device 106 to connect. If more than a single vehicle 102 is detected in proximity to the access device 106, control passes to operation 908.

At operation 906, the access device 106 allows connection to the selected or only vehicle 102. After operation 906 the process 900 ends.

At operation 908, the access device 106 refrains from connecting to any of the vehicles 102. This may accordingly prevent the access device 106 from inadvertently unlocking or showing welcome indications from the various vehicles 102 that are in proximity to the access device 106.

At operation 910, the access device 106 displays the vehicle selection user interface 800. In an example, access device 106 displays, to the device HMI 118, a pop-up of a list of access devices 106 that are detected and correlated with users 108. The device HMI 118 may further illustrate a suggested one of the vehicles 102. The suggested vehicles 102 may be a most recently used vehicle 102, and/or a most frequently used vehicle 102.

At operation 912, the device HMI 118 receives a selection via the vehicle selection user interface 800 from a user 108 of which vehicle 102 is to be allowed to connect to the access device 106. After operation 912, control passes to operation 906 to cause the access device 106 to allow connection to the selected vehicle 102.

Variations on the disclosed approaches are possible. For example, in a situation where the access device 106 remains within the vehicle 102 and the user 108 is outside the vehicle 102, there may be cases where the access device 106 remains connected to the vehicle 102. For example, the user 108 may remain within a predefined range from the vehicle 102 as detected using the sensor suite 114 and/or the access device 106 may remain within a signal strength threshold between the vehicle 102 and the access device 106 indicating that the access device 106 remains in the cabin. In such a situation, call and/or message handling for the access device 106 may be configured to address the continued connection with the location of the user 108 being outside the vehicle 102.

In some examples, a received call may be dispatched via exterior speakers of the vehicle 102 and/or may be answerable using exterior microphones of the vehicle 102. In some examples, the vehicle 102 may utilize exterior cameras or other sensors of the sensor suite 114 to ensure that only the user 108 who is correlated to the access device 106 can answer the call and communicate with the calling party. In some examples, incoming phone calls may be configured to be sent directly to voicemail responsive to the access device 106 being left in the vehicle 102 and the user 108 is outside the vehicle 102.

In some examples, the user 108 correlated to the access device 106 may configure phone calls to not display on the vehicle HMI 116 when the user 108 is outside the vehicle 102 (e.g., where the user 108 has stepped out to refuel or enter a store). In such a situation the user 108 may not want occupants of the vehicle 102 seeing that calls or messages are being received to the access device 106.

In some examples, an out-of-vehicle assistant may reply to incoming messages with a pre-configured away reply. An example of such a reply may read for example “I stepped out of my vehicle for a short duration – I will reply when I return.” In some examples, responsive to the user 108 returning, the vehicle 102 may then allow the user 108 to review any missed calls and messages.

If the access device 106 is left in the vehicle 102 and the user 108 is outside the vehicle 102, there may be cases where the access device 106 remains connected to the vehicle 102.

In another situation, the access device 106 is taken with the user 108 from the vehicle 102 and the user 108 is outside the vehicle 102. In this case, the user 108 remains within a predefined range from the vehicle 102 and the access device 106 remains within a signal strength threshold between the vehicle 102 and the access device 106 to continue the connection but where the access device 106 is unlikely still within the cabin of the vehicle 102. In such a situation, the call and/or message handling for the access device 106 may be configured to address the location of the user 108 and access device 106 being outside the vehicle 102.

In some examples, calls may be directed by the vehicle 102 straight to voicemail, such that when the user 108 returns to the vehicle 102, the vehicle HMI 116 may be used to inform the user 108 of the missed notifications and/or alerts. In some examples, the vehicle HMI 116 may maintain entertainment, music, navigation, and/or other applications that do not involve communications directed to the user 108 for those occupants remaining in the vehicle 102.

In some examples, settings may be differentiated for app control, so occupants of the vehicle 102 may continue to control various application as configured by the user 108, such as a music application while the user 108 correlated with the access device 106 retains full control over the messaging functions such as calls and text messages.

In yet another situation, a charger mode may be implemented by the vehicle 102. In an example, the vehicle 102 may determine when the vehicle 102 is in the charger mode (e.g., plugged in for charging and there is additional time remaining to charge), in combination with user settings 110 that can be compiled for the vehicle 102 when in that mode (e.g., greater flexibility on using phone functions of the vehicle 102 when outside the vehicle 102, auto assist functionality for calls). This charger mode may implement one or more of the examples discussed herein with respect to the other situations, but may be automatically activated responsive to the vehicle 102 being connected to a charger.

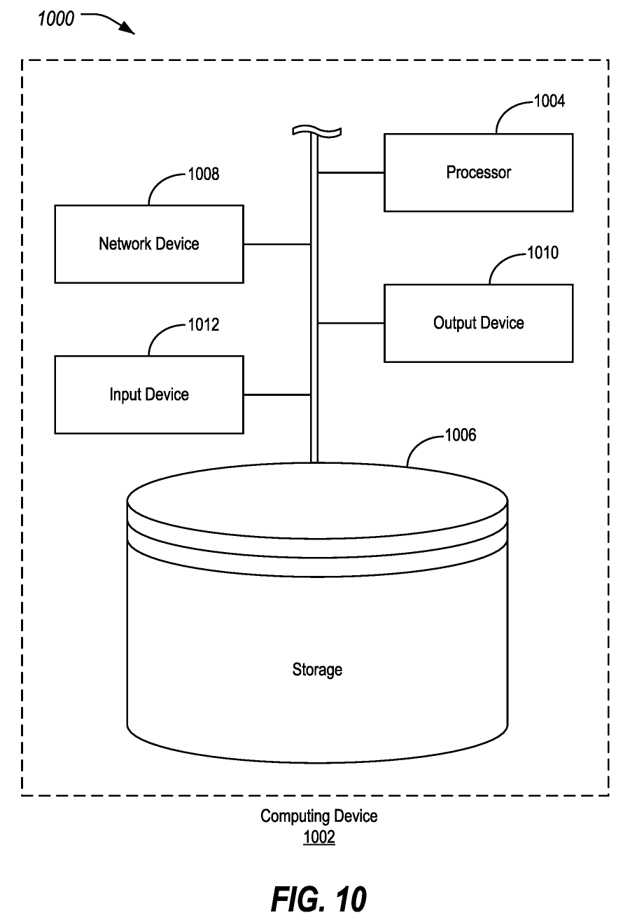

FIG. 10 illustrates an example computing device 1002 for use in implementing the vehicle occupant entry and exit wireless connection monitoring and severance. Referring to FIG. 10, and with reference to FIGS. 1-9, the vehicles 102, access controller 104, access devices 106, wireless transceivers 112, sensor suite 114, vehicle HMI 116, device HMI 118 are examples of such computing devices 1002. Computing devices 1002 generally include computer-executable instructions, where the instructions may be executable by one or more computing devices 1002. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein (e.g., the process 400, the process 600, the process 900). Such instructions and other data, such as the user settings 110 may be stored and transmitted using a variety of computer-readable media.

As shown, the computing device 1002 may include a processor 1004 that is operatively connected to a storage 1006, a network device 1008, an output device 1010, and an input device 1012. It should be noted that this is merely an example, and computing devices 1002 with more, fewer, or different components may be used.

The processor 1004 may include one or more integrated circuits that implement the functionality of a central processing unit (CPU) and/or graphics processing unit (GPU). In some examples, the processors 1004 are a system on a chip (SoC) that integrates the functionality of the CPU and GPU. The SoC may optionally include other components such as, for example, the storage 1006 and the network device 1008 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 1004 executes stored program instructions that are retrieved from the storage 1006. The stored program instructions, accordingly, include software that controls the operation of the processors 1004 to perform the operations described herein. The storage 1006 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100.

The GPU may include hardware and software for display of at least two-dimensional (2D) and optionally three-dimensional (3D) graphics to an output device 1010. The output device 1010 may include a graphical or visual display device, such as an electronic display screen, projector, printer, or any other suitable device that reproduces a graphical display. As another example, the output device 1010 may include an audio device, such as a loudspeaker or headphone. As yet a further example, the output device 1010 may include a tactile device, such as a mechanically raiseable device that may, in an example, be configured to display braille or another physical output that may be touched to provide information to an occupant.

The input device 1012 may include any of various devices that enable the computing device 1002 to receive control input from occupants. Examples of suitable input devices 1012 that receive human interface inputs may include keyboards, mice, trackballs, touchscreens, microphones, graphics tablets, and the like.

The network devices 1008 may each include any of various devices that enable the described components to send and/or receive data from external devices over networks. Examples of suitable network devices 1008 include an Ethernet interface, a Wi-Fi transceiver, a cellular transceiver, or the BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle for wireless connection monitoring and severance, comprising:
a wireless transceiver configured to support wireless communication with access devices;
a sensor suite configured to track locations of users in proximity to the vehicle; and
an access controller operatively connected to the wireless transceiver and the sensor suite, wherein the access controller is configured to:
track device locations of access devices using the wireless transceiver,
track user locations of users using the sensor suite,
correlate the access devices with the users based on correspondence of the device locations to the user locations,
responsive to a single correlated access device being detected, establish a wireless connection with the correlated access device, and
responsive to a plurality of correlated access devices being detected, refrain from establishing the wireless connection until one or more of the users enter the vehicle.

2. The vehicle of claim 1, wherein the access controller is further configured to:
responsive to user settings of the vehicle indicating that the vehicle is in an owner mode, connect to an access device of an owner user of the vehicle according to the user settings; and
refrain from connecting to other correlated access devices.

3. The vehicle of claim 1, further comprising a vehicle human machine interface (HMI), operatively connected to the access controller, wherein the access controller is further configured to:
responsive to the plurality of correlated access devices being detected, display, on the vehicle HMI, a list of the correlated access devices;
receive a user selection of one of the correlated access device from the list; and
establish the wireless connection with the selected one of the correlated access devices.

4. The vehicle of claim 3, wherein the access controller is further configured to:
indicate a recommendation on the vehicle HMI, the recommendation indicating which of the correlated access devices is recommended for reconnection, the recommendation being determined as a most recently connected correlated access device, most commonly connected correlated access device, owner correlated access device, and/or the correlated access device in a driver position in the vehicle.

5. The vehicle of claim 1, wherein the access controller is further configured to track the user locations using object recognition techniques on data from the sensor suite to distinguish human users from other objects.

6. The vehicle of claim 1, wherein the access controller is further configured to:
terminate the wireless connection between the vehicle and the access device responsive to determining that the correlated access device is exiting; and
prevent automatic reconnection of the access device to the vehicle for a predefined timer period after the wireless connection is terminated.

7. The vehicle of claim 1, wherein the access controller is further configured to:
maintain the wireless connection while a user associated with the access device is outside the vehicle, provided the user is within a predefined range from the vehicle; and
suppress notifications to a vehicle HMI while maintaining use of entertainment and navigation applications until the user returns to inside the vehicle.

8. The vehicle of claim 7, wherein the access controller is further configured to reply to incoming messages with a pre-configured away reply while the user is outside the vehicle.

9. The vehicle of claim 7, wherein the access controller is further configured to indicate any missed messages or calls responsive to the user returning to inside the vehicle.

10. A method for wireless connection monitoring and severance, comprising:
tracking device locations of access devices using a wireless transceiver of a vehicle, the wireless transceiver being configured to support wireless communication with the access devices;
tracking user locations of users using a sensor suite of the vehicle, the sensor suite being configured to track the users in proximity to the vehicle;
correlating the access devices with the users, using an access controller, based on correspondence of the device locations to the user locations;
responsive to a single correlated access device being detected, establishing a wireless connection with the correlated access device; and
responsive to a plurality of correlated access devices being detected, refraining from establishing the wireless connection until one or more of the users enter the vehicle.

11. The method of claim 10, further comprising:
responsive to user settings of the vehicle indicating that the vehicle is in an owner mode, connecting to an access device of an owner user of the vehicle according to the user settings, responsive to the correlated access device of the owner user being detected inside the vehicle; and
refraining from connecting to other correlated access devices.

12. The method of claim 10, further comprising:
displaying, on a vehicle HMI, a list of the correlated access devices;
receiving a user selection of one of the correlated access device from the list; and
establishing the wireless connection with the selected one of the correlated access devices.

13. The method of claim 12, further comprising:
indicating a recommendation on the vehicle HMI, the recommendation indicating which of the correlated access devices is recommended for reconnection, the recommendation being determined as a most recently connected correlated access device, most commonly connected correlated access device, owner correlated access device, and/or the correlated access device in a driver position in the vehicle.

14. The method of claim 10, further comprising tracking the user locations using object recognition techniques on data from the sensor suite to distinguish human users from other objects.

15. The method of claim 10, further comprising:
terminating the wireless connection between the vehicle and the access device responsive to determining that the correlated access device is exiting; and
preventing automatic reconnection of the access device to the vehicle for a predefined timer period after the wireless connection is terminated.

16. The method of claim 10, further comprising:
maintaining the wireless connection while a user associated with the access device is outside the vehicle, provided the user is within a predefined range from the vehicle; and
suppressing notifications to a vehicle HMI while maintaining use of entertainment and navigation applications until the user returns to inside the vehicle.

17. The method of claim 16, further comprising replying to incoming messages with a pre-configured away reply while the user is outside the vehicle.

18. The method of claim 16, further comprising indicating any missed messages or calls responsive to the user returning to inside the vehicle.

19. A non-transitory computer-readable medium comprising instructions for wireless connection monitoring and severance that, when executed by one or more processors of an access controller of a vehicle, cause the vehicle to perform operations including to:
track device locations of access devices using a wireless transceiver of a vehicle, the wireless transceiver being configured to support wireless communication with the access devices;
track user locations of users using a sensor suite of the vehicle, the sensor suite being configured to track the users in proximity to the vehicle;
correlate the access devices with the users, using an access controller, based on correspondence of the device locations to the user locations;
responsive to a single correlated access device being detected, establish a wireless connection with the correlated access device; and
responsive to a plurality of correlated access devices being detected, refrain from establishing the wireless connection until one or more of the users enter the vehicle.

20. The non-transitory computer-readable medium of claim 19, further instructions that, when executed by the one or more processors of the access controller, cause the vehicle to perform operations including to:
terminate the wireless connection between the vehicle and the access device responsive to determining that the correlated access device is exiting; and
prevent automatic reconnection of the access device to the vehicle for a predefined timer period after the wireless connection is terminated.

21. An access device configured for wireless communication with a plurality of vehicles, the access device comprising:
a wireless transceiver configured to support wireless communication with vehicles;
a device HMI; and
a processor operatively connected to the wireless transceiver, wherein the processor is configured to:
track vehicles using the wireless transceiver,
responsive to a single vehicle being detected, establish a wireless connection with the vehicle, and
responsive to multiple vehicles being detected:
refrain from connecting to any of the multiple vehicles,
display a vehicle selection user interface on the device HMI, the vehicle selection user interface listing the multiple vehicles detected,
receive, via the vehicle selection user interface, a selection of a specific vehicle, and
allow the access device to connect to the specific vehicle while refusing to connect to any other vehicles of the multiple vehicles.

22. The access device of claim 21, wherein the vehicle selection user interface displays a list of the multiple vehicles, including, for each detected vehicle, at least one of: a name associated with the detected vehicle, a time of last connection with the access device, and a distance of the detected vehicle from the access device.

23. The access device of claim 21, wherein the vehicle selection user interface includes a recommendation for one of the multiple vehicles based on one or more criteria including a most recently connected vehicle, a most frequently connected vehicle, or a nearest detected vehicle.

24. The access device of claim 23, wherein the access device is further configured to track vehicle locations of the vehicles using signal trilateration or triangulation and use the vehicle locations to determine the nearest detected vehicle.

25. The access device of claim 23, wherein the access device is further configured to store historical connection data for previously connected vehicles and use the historical connection data to determine the most recently connected vehicle and/or the most frequently connected vehicle.
